(19) United States
(12) Patent Application Publication
(10) Pub. No.: US 2002/0021428 A1
(43) Pub. Date: Feb. 21, 2002

(54) Charged-particle-beam microlithography stage including actuators for moving a reticle or substrate relative to the stage, and associated methods

(76) Inventors: Katsushi Nakano, Kumagaya-shi (JP); Shinobu Tokushima, Kawasaki-city (JP); Yukiharu Okubo, Kumagaya-shi (JP)

Correspondence Address: KLARQUIST SPARKMAN CAMPBELL, LEIGH & WHINSTON, LLP, One World Trade Center, Suite 1600, 121 S.W. Salmon Street, Portland, OR, 97204, US

(21) Appl. No.: 09/874,156

(22) Filed: Jun. 4, 2001

(30) Foreign Application Priority Data
Jun. 5, 2000 (JP) 2000-167437

(51) Int. Cl. G03B 27/42

(52) U.S. Cl. 355/53

(57) ABSTRACT

Stages are disclosed for used in a charged-particle-beam (CPB) microlithography apparatus for holding a reticle or substrate (wafer) without affecting the charged particle beam. An exemplary stage, which can be a reticle stage or wafer stage, includes at least one actuator situated and configured to move the reticle or substrate relative to the stage. The actuator is non-magnetic and is configured to exhibit at least two degrees of freedom relative to the stage to cause movement of the reticle or substrate. An exemplary actuator is a piezoelectric element configured as a hollow cylinder or integrated into an assembly including multiple levers connected together by flexures. The actuators can cause the reticle or wafer to be moved linearly and/or rotated relative to the stage. For example, the wafer can be rotated using multiple actuators, and any deviation in wafer rotation can be compensated for by an adjustment to the CPB optical system.

### FIELD OF THE INVENTION

This invention pertains to microlithography (projection-transfer of a pattern, defined by a reticle or mask, onto a sensitive substrate such as a semiconductor wafer. Microlithography is a key technology used in the manufacture of microelectronic devices such as integrated circuits, displays, magnetic pickup heads, micromachines, and the like. More specifically, the invention pertains to microlithography performed using a charged particle beam (e.g., electron beam or ion beam) as an energy beam.

### BACKGROUND OF THE INVENTION

As the density and miniaturization of microelectronic devices has continued to increase, the accuracy and resolution demands imposed on microlithographic methods and apparatus also have increased. It has become very difficult to meet current requirements of accuracy and resolution using light (UV light) as a microlithographic energy beam. As a result, substantial effort is being expended in the development of “next-generation” microlithography technology. A major contender for the next-generation microlithography technology is charged-particle-beam (CPB) microlithography, which offers prospects of substantially increased resolution and accuracy for reasons similar to why electron microscopy achieves better resolution than optical microscopy.

CPB microlithography utilizes a reticle that defines the pattern to be transferred to a suitable “sensitive” substrate. Currently, a typical reticle is made from a silicon wafer having a diameter of 200 mm, which provides an indication of how large a reticle can be. However, at any given instant, a typical charged particle beam used for illuminating a reticle has a transverse area measuring only about 250 μm×250 μm. Consequently, a reticle for CPB microlithography typically is divided into a large number of “subfields” each defining a respective portion of the overall pattern defined by the reticle. The subfields are sized for individual illumination by the beam. The subfields are exposed individually in sequential order onto the substrate in a manner such that the subfield images are arranged in a proper manner contiguously with each other (i.e., “stitched” together) so as to form a complete “die” (having dimensions of many mm²) on the substrate.

In a typical divided reticle, the subfields are arranged in rows and “stripes.” A row typically contains the number of subfields that can be exposed sequentially simply by deflecting a CPB “illumination beam” in a lateral direction relative to an optical axis. A stripe contains multiple rows. Hence, during exposure of a stripe, the reticle (mounted on a reticle stage) and substrate (mounted on a “wafer stage”) are moved relative to each other in a continuous scanning manner in a first lateral scanning direction as the rows are exposed sequentially. Meanwhile, the charged particle beam (illumination beam) is scanned in a second lateral scanning direction (perpendicular to the first lateral scanning direction) to scan the subfields in each row. After completing exposure of a stripe, the reticle stage and wafer stage are moved to position the next stripe for exposure, and so on until the entire reticle pattern is exposed onto a die on the substrate.

As noted above, the reticle and substrate are mounted on a reticle stage and a wafer stage, respectively, to provide controlled movements of the reticle and substrate during exposure and to move the reticle and substrate as required for reference positioning. Each stage typically is configured to move the respective reticle or substrate in any of various axial directions in an X-Y-Z perpendicular coordinate system in which the Z-axis is the optical axis. Each stage also is configured to rotate the respective reticle or substrate in a plane parallel to the X-Y plane about a rotational axis parallel to the Z-axis. This rotation is termed θ-direction movement.

FIG. 9 illustrates, in a schematic manner, the respective positions and structures of the reticle stage and wafer stage in a CPB microlithography apparatus. An irradiation-optical system 32 is provided relative to a vacuum chamber 31. A reticle stage 33 is situated in the vacuum chamber 31. A reticle 34 is mounted to the reticle stage 33 and is illuminated by the irradiation-optical system 32. The reticle stage 33 comprises a θ-stage 33a configured to hold the reticle 34 and to be rotated as required about a Z-axis (parallel to the optical axis AX) in the horizontal (X-Y) plane. The θ-stage 33a is mounted to a three-dimensional stage assembly comprising an X-axis stage 33b, a Y-axis stage 33c, and a Z-axis stage 33d.

The particular reticle stage 33 shown in FIG. 9 is configured to hold multiple reticles 34. More specifically, multiple reticles 34 are mounted on the θ-stage 33a. Multiple reticles are used because the exposure of a single layer of a die on a substrate frequently requires multiple reticles that desirably are mounted on the reticle stage 33. At any particular instant during exposure, a charged-particle illumination beam emitted from the irradiation-optical system 32 is incident on one of the reticles 34.

A projection-optical system 35 is situated downstream of the reticle stage 33. Hence, as each pattern portion is illuminated by the irradiation-optical system, an image of the respective pattern portion is formed by the projection-optical system 35 on a substrate (“wafer”) 37. The wafer 37 is mounted on a wafer stage 36 situated downstream of the projection-optical system 35. The wafer stage 36 comprises a θ-stage 36a that holds the wafer 37 and is rotatable about a Z-axis (parallel to the optical axis AX) in the horizontal (X-Y) plane. The θ-stage 36a is mounted to a three-dimensional stage assembly comprising an X-axis stage 36b, a Y-axis stage 36c, and a Z-axis stage 36d.

The combination of the irradiation-optical system 32 and the projection-optical system 35 is termed the “CPB optical system.” The CPB optical system is arranged along the optical axis AX.

The X and Y positions of the stages 33a-33d of the reticle stage 33 are measured using respective X- and Y-interferometers (not shown but well understood in the art). These X- and Y-interferometers also determine the θ position of the reticle stage 33. Similarly, the respective X and Y positions of the stages 36a-36d of the wafer stage 36 are measured using respective X- and Y-interferometers (not shown but well understood in the art). These X- and Y-interferometers also determine the θ position of the wafer stage 36. Each X- and Y-interferometer utilizes at least one respective laser beam directed at a moving mirror on the respective stage. The respective Z positions of the reticle stage 33 and wafer stage 36 are measured by respective auto-focus (“AF”) sensors (not shown but well understood in the art).

The reticles 34 and wafer 37 are each placed on their respective stages 33, 36 by a respective robot called a loader. The positional accuracy of a typical loader is at the micrometer level, which is insufficient for achieving the nanometer positional accuracy required for exposure of a typical integrated circuit. Alignment of a reticle 34 and wafer 37 with the irradiation-optical system 32 and projection-optical system 35 is performed as follows.

Before exposing the first pattern on a wafer, there are no pattern features or alignment marks on the wafer 37. At time of exposing the first pattern, various alignment marks (typically hundreds of marks) also are exposed onto the wafer. These alignment marks are used to align subsequently exposed patterned layers with the previously exposed patterned layers. To determine the position and rotation of the wafer 37 relative to the moving mirrors on the wafer stage, measurements using only two marks is sufficient. But, to reduce measurement noise, measurements usually are made at least 10 randomly selected marks. This alignment technique is well known in the art, and is termed “Enhanced Global Alignment” or “EGA.” The reticle 34 also has alignment marks that are used to perform alignment of the reticle 34 and reticle stage 33.

The alignment marks on the wafer 37 are of two types. One type is used for optical measurements, and another type is used for measurements performed using the charged particle beam. Optical measurements are made using a microscope 39. Similarly, measurements performed on optical alignment marks on the reticle 34 are performed using a microscope 38. The microscopes 38, 39 are mounted to and situated adjacent the projection-optical system 32. Each microscope 38, 39 has a respective optical axis located a respective predetermined distance from the optical axis AX of the CPB-optical system. CPB-based measurements of marks on the reticle and wafer are performed using the CPB-optical system. 5

Each alignment mark has a respective nominal position, which is the respective “ideal” position of the mark when the loader places the wafer on the exact center of the wafer stage 36 with zero rotation (θ) error.

The distance between the axis AX of the CPB-optical system and the optical axis of a microscope 38, 39 is initially established using a scale. The scale comprises marks having respective positions that are measurable by the CPB-optical system and the respective microscope.

The distance between a mark intended for optical measurements and a corresponding mark intended for CPB-based measurements is reliably constant and is usually measured in advance. (The CPB-based measurements are performed using the CPB-optical system, and the optical measurements are performed using the optical microscope.) From these measurements, the distance between the two optical axes can be determined. This is followed by EGA-based measurements of the wafer. If a correction is required, then the wafer is moved (X, Y, and θ) under the projection-optical system 35, as effected by the X-stage 36b, Y-stage 36c, and θ-stage 36a. (If the movement distance is very small, then the correction can be performed using the CPB-optical system.

In the procedure summarized above, different pattern features are measured twice. Alternatively, deviations from respective reference positions can be ascertained with greater accuracy by measuring three or more different pattern features three or more times each.

As discussed above, each of the reticle stage 33 and wafer stage 36 has a rotation function used for correcting alignment deviations of the reticles and wafer, respectively, in a rotational (θ) sense. This rotation function is termed herein a “rotation mechanism” or θ-stage 33a, 36a, respectively.

For each of the reticle stage 33 and wafer stage 36, the rotation mechanism 33a, 36a, respectively, is provided on the portion of the stage that is movable in the X, Y, and Z directions. Rotation mechanisms conventionally utilize electromagnetic motors. However, electromagnetic motors are difficult to use in a CPB microlithography apparatus because such motors usually contain permanent magnets. Because the permanent magnets emit magnetic fields that bend the charged particle beam, they should not be situated near a stage. Also, CPB microlithography is performed in a vacuum chamber 31. Whenever a complex mechanical device such as a motor is placed in a vacuum, a substantial risk is created of outgassing or release of particles from the motor that contaminate the apparatus, the reticle, and the substrate. In addition, the use of metals in the vicinity of a stage is problematic. If a metal object is situated near a lens of the projectionoptical system 35 (wherein the lens generates a magnetic field), an eddy current is created inside the metal object. These eddy currents disrupt the magnetic field generated by the lens, and disrupted magnetic fields have an adverse effect on the charged particle beam.

As noted above, multiple reticles 34 can be placed on the reticle stage 33. However, if the angular orientation of the reticles 34 relative to each other changes from one reticle to the next, then the θ-stage will require adjustment each time a new reticle 34 on the stage 33 is selected for exposure. Having to perform such an alignment for each reticle on the stage disadvantageously reduces the throughput of the CPB microlithography apparatus.

As noted above, the CPB-optical system not only can focus an image but also can rotate an image very accurately within a limited range. In such a configuration, the θ-stage need not be a fine stage, but nevertheless must have sufficient range of motion to turn the wafer within the tolerance range of the imagerotation ability of the CPB-optical system. Conventional θ-stages do not normally move in real time. If it were possible to configure a θ-stage that could move in real time, then it would not be necessary to stack the θ-stage on the X-, Y-, and Z-stages, thereby significantly simplifying the stage system.

### SUMMARY OF THE INVENTION

In view of the shortcomings of conventional apparatus and methods as summarized above, an object of the invention is to provide charged-particle-beam (CPB) microlithography apparatus operable to move or rotate a reticle or wafer, e.g., relative to the respective stage, without affecting the charged particle beam.

To such end, and according to a first aspect of the invention, stages are provided (in the context of a CPB microlithography apparatus) for holding the reticle or substrate. An embodiment of the stage comprises an X-directionmovement stage portion, a Y-direction-movement stage portion, a Z-directionmovement stage portion, and at least one actuator. The X-direction-movement stage portion is configured to move the reticle or substrate along an X-axis direction; the Y-direction-movement stage portion is configured to move the reticle or substrate along a Y-axis direction; and the Z-direction-movement stage portion configured to move the reticle or substrate along a Z-axis direction. The actuator is situated and configured to move the reticle or substrate relative to the stage. The actuator is made of a non-magnetic material and is configured to exhibit at least two degrees of freedom of movement relative to the stage sufficient to cause said movement of the reticle or substrate. In general, the stage can be a wafer stage or reticle stage, or both types of stages can be provided on the CPB microlithography apparatus.

The actuator can be any of various types. For example, the actuator can have a proximal end mounted to the stage and a distal free end configured to be moved relative to the proximal end. For example, the actuator can be a cylindrical piezoelectric element (e.g., “tube actuator”), wherein the proximal end of the actuator is a first end of the piezoelectric element and the distal end is a second end of the piezoelectric element. In another example, the actuator can comprise first and second levers, and first and second piezoelectric elements (e.g., “piezo stacks as known in the art). The first lever is connected to the proximal end via a first flexure, and the second lever is connected to the first lever via a second flexure, wherein the first and second flexures are oriented at right angles relative to each other. The first piezoelectric element is situated and configured to cause pivoting motion of the first lever about the first flexure relative to the proximal end whenever the first piezoelectric element is appropriately energized. Similarly, the second piezoelectric element is situated and configured to cause pivoting motion of the second lever about the second flexure relative to the first lever whenever the second piezoelectric element is appropriately energized.

In another example, the actuator can comprise two laminated piezoelectric elements (e.g., respective “piezo stacks”) each having a proximal end mounted to the stage and a distal free end configured to be moved relative to the proximal end. The piezoelectric elements are situated relative to each other such that the respective distal free ends extend angularly from the stage toward the reticle or substrate, as well as angularly toward each other.

Desirably, multiple actuators are used. For example, at least three actuators can be situated peripherally relative to the reticle or substrate so as to support, whenever the actuators are appropriately energized, the reticle or substrate in a tripod manner relative to the stage. In this configuration, the actuators can be located substantially equi-angularly relative to each other. Each actuator can have a proximal end mounted to the stage and a distal free end configured to be moved relative to the proximal end.

The actuator can be configured to move the reticle or substrate, while the reticle or substrate is resting on a support, by lifting the reticle or substrate relative to the support, moving the reticle or substrate relative to the support, and then replacing the reticle or substrate on the support. Alternatively, the actuator can be configured to manipulate the reticle or substrate relative to the stage so as to control a positional deviation of the reticle or substrate from a reference position. This allows a position of the reticle or substrate to be maintained to within a range that can be compensated for by a charged-particle-beam optical system.

The stage can be configured to hold multiple reticles or substrates. In such a configuration, the stage can comprise multiple actuators situated and configured to move a respective reticle or substrate relative to the stage. Each such actuator is made of a non-magnetic material and is configured to exhibit at least two degrees of freedom of movement relative to the stage sufficient to cause said movement of the reticle or substrate.

According to another aspect of the invention, CPB microlithography apparatus are provided. An embodiment of such an apparatus comprises an irradiation-optical system, a projection-optical system, and a stage for holding a reticle or substrate relative to the irradiation-optical system and projection-optical system. The stage comprises an X-direction-movement stage portion, a Y-direction-movement stage portion, and a Z-direction-movement stage portion as summarized above. The stage also includes at least one actuator having, e.g., any of the various configurations as summarized above. The stage can be configured as a wafer stage or as a reticle stage.

According to yet another aspect of the invention, methods are provided (in the context of a CPB microlithography method) for moving the reticle or substrate relative to the optical axis. In an embodiment of such a method, the reticle or substrate is placed on a stage. An actuator is provided relative to the stage. The actuator is made of a non-magnetic material and is configured to exhibit at least two degrees of freedom of movement relative to the stage. The actuator is energized so as to cause movement of the actuator relative to the stage, such that the actuator causes movement of the reticle or substrate relative to the stage. The actuator that is provided in these methods can have any of the various configurations as summarized above. For example, the actuator can have a proximal end mounted to the stage and a free distal end, wherein energizing the actuator causes the distal end to contact the reticle or substrate in a manner resulting in movement of the reticle or substrate relative to the stage.

The foregoing and additional features and advantages of the invention will be more readily apparent from the following detailed description, which proceeds with reference to the accompanying drawings.

### BRIEF DESCRIPTION OF THE DRAWINGS

FIG. 1(A) is an elevational view of a wafer stage, for a charged-particle-beam (CPB) microlithography apparatus, according to a first representative embodiment of the invention, and

FIG. 1(B) is an oblique view of the Z-stage of the FIG. 1(A) configuration.

FIG. 2(A) is a lateral oblique view of a tubular actuator (configured as a “tube actuator”) as used in the first representative embodiment.

FIGS. 2(B)-2(C) depict respective steps in the energization of the actuator of FIG. 2(A) in a manner causing the distal end of the actuator to move in the Z-direction.

FIGS. 2(D)-2(E) depict respective steps in the energization of the actuator of FIG. 2(A) in a manner causing the distal end of the actuator to move in the θ-direction.

FIGS. 3(A)-3(B) depict respective steps in the energization of the actuator of FIG. 2(A) in a manner causing the distal end of the actuator to move in the “r” direction.

FIG. 3(C) is a plan view showing movement of the wafer laterally to the right, as described in the first representative embodiment.

FIG. 4(A) is an oblique view of an actuator with levers and flexures, according to the second representative embodiment.

FIGS. 4(B)-4(C) depict respective steps in the energization of the actuator of FIG. 4(A) in a manner causing the distal end of the actuator to move in the Z-direction.

FIGS. 4(D)-4(E) depict respective steps in the energization of the actuator of FIG. 4(A) in a manner causing the distal end of the actuator to move in the θ-direction.

FIGS. 5(A)-5(E) depict the results of respective steps in a sequence of actuator energizations serving to move a wafer 6 laterally to the right in the figure, as described in the third representative embodiment.

FIG. 6 is an elevational view of a portion of a CPB microlithography apparatus in which the reticle stage accommodates multiple reticles each supported by multiple actuators, and the wafer stage (as shown) accommodates a single wafer supported by multiple actuators, as described in the fourth representative embodiment.

FIG. 7 is a flow chart of certain steps in a process for manufacturing a microelectronic device, as described in the fifth representative embodiment.

FIG. 8 is a flow chart of the microlithography step shown in FIG. 7.

FIG. 9 is an elevational view of the reticle stage and wafer stage of a conventional CPB microlithography apparatus.

### DETAILED DESCRIPTION

Representative embodiments of the invention are described with reference to the drawings that are not intended to be limiting in any way.

First Representative Embodiment

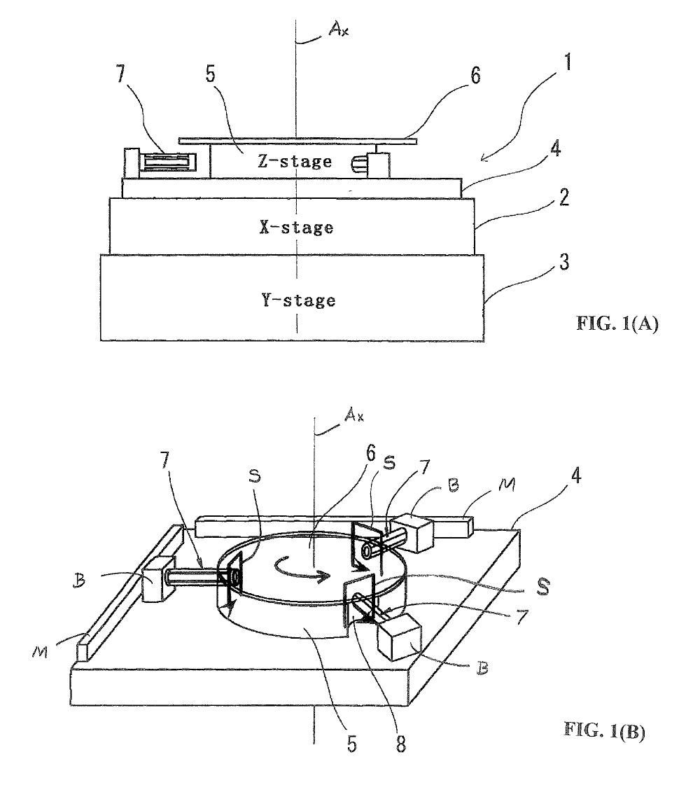

A first representative embodiment of a wafer stage 1, for use in a charged-particle-beam (CPB) microlithography apparatus is shown in FIGS. 1(A)-1(B). In a CPB microlithography apparatus, the reticle stage and wafer stage have many structural similarities. Consequently, general principles of the wafer stage 1 as described according to this embodiment can be applied to a reticle stage, and a CPB microlithography apparatus according to the invention can be similar to a conventional CPB microlithography apparatus except for the wafer stage and/or reticle stage.

The wafer-stage embodiment of FIGS. 1(A)-1(B) comprises an X-stage 2, a Y-stage 3, a base 4, and a Z-stage 5. The wafer stage 1 is configured such that the base 4 rests on the X-stage 2 and the Y-stage 3, with the Z-stage 5 mounted on the base 4. The Z-stage 5 includes an electrostatic chuck (not shown but well understood in the art) for mounting the wafer 6 to the Z-stage 5. Mounted to the base are movable mirrors M for respective interferometers. Also included are actuators 7, as discussed below, for laterally and rotationally displacing the wafer 6 relative to the Z-stage 5.

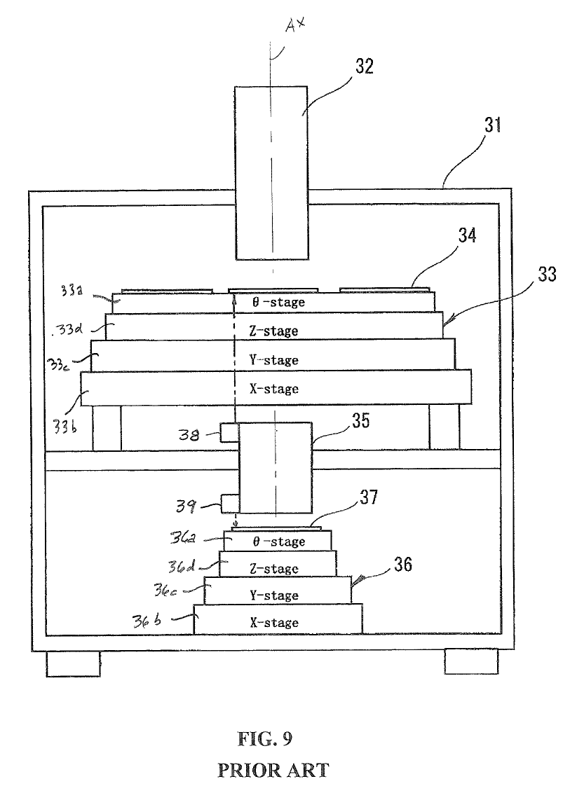

The θ-stages 33a, 36a present in the conventional stage configuration shown in FIG. 9 are not included with this embodiment. Instead, arranged circumferentially around the Z-stage 5 are three actuators 7, oriented substantially radially at 120° intervals (substantially equal angular intervals) about the optical axis Ax. The actuators 7 provide sufficient rotational motion of the wafer 6 about the optical axis Ax, thereby eliminating the need for a θ-stage, as described below. The resulting “tripod” support of the wafer 6 (or reticle) by three actuators 7 provides stable support for the wafer. “Substantially” equi-angular placement of the actuators 7 means that the actual locations of the actuators 7 need not be exactly equalangular, so long as the requisite stability of support of the wafer or reticle is achieved.

In this embodiment, each actuator 7 comprises a “tube scanner” made of a piezoelectric element configured as a longitudinally extended hollow cylinder, as described further below. Each actuator 7 has a proximal end that is attached to a respective block B affixed to the base 4. The respective distal free ends of the actuators 7 extend from the respective blocks B radially toward the optical axis Ax in cantilever fashion. The distal end of each actuator 7 extends into a respective cutout 8 of the Z-stage 5, as shown in FIG. 1(B). In FIG. 1(B), to illustrate structure more clearly, part of the Z-stage 5 and wafer 6 appear transparent.

Rotating the wafer 6 using the actuators 7 is described first with reference to FIG. 1(B). First, the electrostatic chuck is turned off. Then, the three actuators 7 are energized in a manner causing their respective distal ends to bend upward synchronously from a “home” position. The distal ends of the actuators 7, when bent upward, contact the under-surface of the wafer 6 and cause the wafer 6 to be lifted off the wafer chuck while being supported underneath at three points (in a tripod manner) by the respective distal ends of the actuators 7.

The three actuators 7 are then energized in a manner causing them to bend synchronously counterclockwise. This motion of the actuators 7 while their respective distal ends are in contact with the under-surface of the wafer 6 causes the wafer 6 to rotate counterclockwise relative to the wafer chuck. The three actuators 7 are then energized in a manner causing bending movement of their respective distal ends synchronously downward, resulting in lowering of the wafer 6 at the respective angular position relative to the optical axis Ax. The wafer 6 is once again supported by the Z-stage 5 (wafer chuck) at this position. The three actuators 7 are returned to their home position in this state. This operation is repeated as many times as necessary to achieve the desired orientation and alignment of the wafer 6. It will be immediately apparent that the actuators 7 could be moved synchronously in an opposite manner to achieve clockwise rotation of the wafer 6 relative to the Z-stage 5.

In the manner described above, the wafer 6 is rotated as required about the optical axis Ax, relative to the Z-stage 5, by coordinated energization of the actuators 7. Any remaining deviation in wafer rotational position is within a range that can be compensated for by the CPB optical system. Hence, even if there is an initial relative deviation in the rotational angles of the reticle and wafer placed on the respective stages, this can be compensated for by mechanical motion (as described above) and by adjustments made to the CPB optical system. Thus, the pattern junctions between the subfields, as exposed on the wafer, are accurately stitched together.

In general, an actuator 7 can be any of various devices that, when energized, can be caused to bend or deform in a manner that, when the actuator is in contact with a reticle or wafer, causes the reticle or wafer to undergo motion relative to the respective stage. The actuator 7 can cause lateral motion and/or rotational motion of the reticle or wafer. The actuator 7 desirably is made of a non-magnetic, nonmetallic material and has at least two degrees of freedom of movement. The actuator 7 does not generate a magnetic field or eddy current that otherwise would disrupt or perturb the charged particle beam, even if the actuator 7 is situated near the CPB optical system.

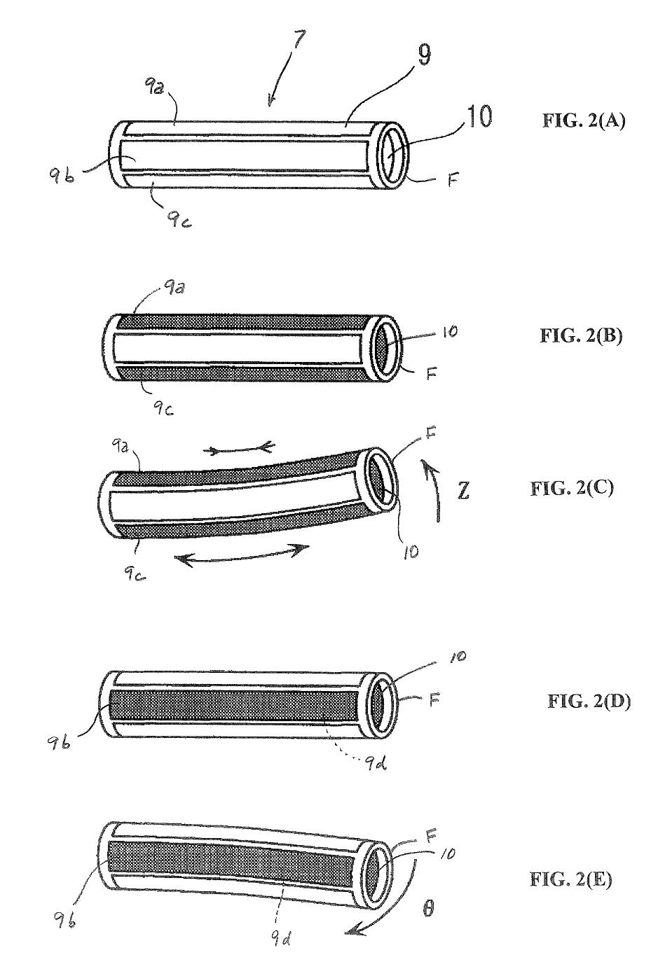

Further detail of an actuator 7 according to this embodiment is shown in FIGS. 2(A)-2(D). In this embodiment, the actuator 7 is configured as a “tube scanner.” (Tube scanners are described in Binnig et al, Rev. Sci. Instrum. 57:1688, 1986, incorporated herein by reference.) The actuator 7 is made of a piezoelectric material desirably having a hollow cylindrical configuration as shown. A piezoelectric element is made of a ceramic, crystalline, or other material that exhibits a spontaneous electric-polarization orientation that can be changed by application of an external electrical field. The external electrical field usually is imposed as a voltage applied across electrodes between which is situated the piezoelectric material. Whenever an external electrical field is applied to a piezoelectric element, the orientation of electric polarization changes, generating stress in the material that causes deformation of the material. A piezoelectric element can be used to cause micro-displacement of a body, and piezoelectric elements are available commercially. By deliberately changing the shape or size of the piezoelectric element by changing the voltage (or manner of applying voltage) to electrodes of the piezoelectric element, various motions of a body can be accomplished.

In the depicted embodiment, an inner electrode 10 is situated on the inside-diameter surface of the cylinder, and longitudinally extended outer electrodes 9 are situated on the outside-diameter surface of the cylinder. In the particular configuration shown in FIG. 2(A), the outer electrodes 9 each extend lengthwise along the cylinder. The outer electrodes 9 are arranged equi-angularly around the outside of the cylinder. The inner electrode 10 extends over substantially the entire inside surface of the hollow cylinder. FIG. 2(A) shows the actuator 7 at a “home” state as dictated by the resting polarization condition of the constituent piezoelectric material. In FIG. 2(B), with the inner electrode 10 typically at electrical ground, respective voltages of opposite polarity are applied to the “upper” and “lower” outer electrodes 9a, 9c (note shading of electrodes). As a result, the respective unit of piezoelectric material sandwiched between the inner electrode 10 and the upper outer electrode 9a contracts, while the respective unit of piezoelectric material sandwiched between the inner electrode 10 and the lower outer electrode 9c expands. The resulting stress causes the distal end of the actuator 7 to bend upward (in the Z-direction) by bimorph action, as shown in FIG. 2(C).

Similarly, as shown in FIGS. 2(D)-2(E), with the inner electrode 10 grounded and voltages of opposite polarity applied to the left and right outer electrodes 9b, 9d, respectively (note shading of electrodes), the distal end of the actuator 7 is caused to bend laterally (i.e., in the θ-direction) by bimorph action. By other selective energizations of the outer electrodes 9a-9d relative to the inner electrode 10, the distal end of the actuator 7 can be made to bend in any direction within the Z- and θ-planes. For example, by selectively applying voltages of appropriate magnitude and polarity to the upper, left, lower, and right outer electrodes 9a-9d, respectively, relative to the inner electrode 10, the motion sequence of the distal end indicated by bold arrows S in FIG. 1(B) can be achieved.

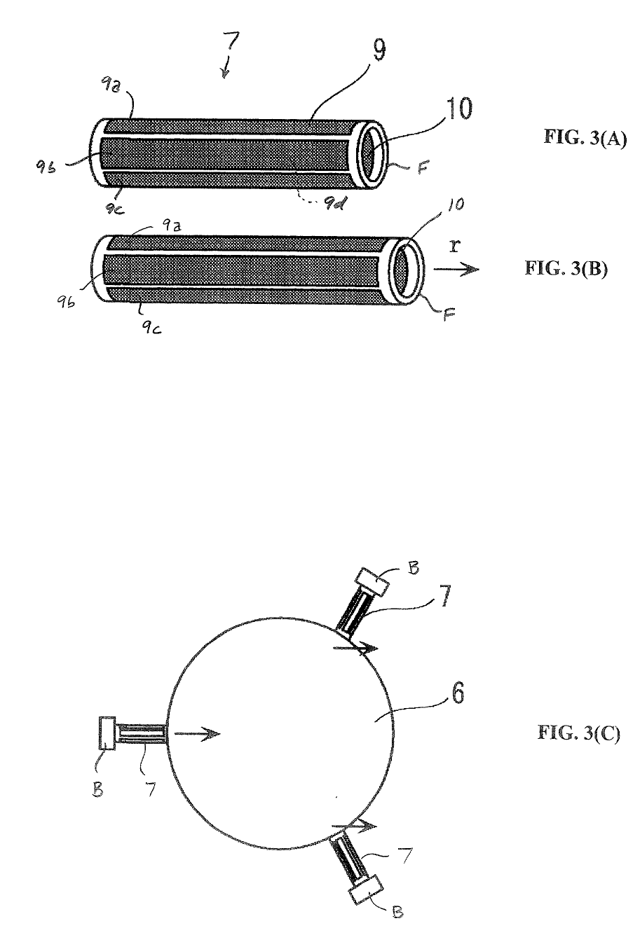

As an alternative to the rotary motion indicated in FIG. 1(B), the wafer 6 can be moved laterally in any direction using the actuators 7. Such motion is indicated in FIGS. 3(A)-3(C). In FIG. 3(A), if the inner electrode 10 is at ground potential and respective voltages of the same magnitude and polarity are applied to each of the four outer electrodes 9a-9d of the actuator 7, then the respective piezoelectric elements extend (or retract, depending upon polarity of applied voltage). Hence, the distal end F of the actuator 7 is displaced in its axial direction (i.e., the “r” direction shown in FIG. 3(B)), wherein the r direction is perpendicular to the Z and θ directions.

In other words, the distal end of an actuator 7 can be displaced in any of the three axial directions by superimposing the r-direction drive voltage over the respective Z-direction and θ-direction drive voltages. For example, as shown in FIG. 3(C), if the actuators 7 are energized to cause their respective distal ends to move to the right after lifting the wafer 6 from the wafer chuck, and the wafer 6 is placed subsequently on the chuck at the de-energized positions of the actuators 7, then the wafer 6 will be moved to the right (arrows). It is possible to move the wafer 6 in any direction by repeating this process as required. It is noted that the manner of movement of the distal end of the actuator 7 need not be over a square path as indicated by the bold arrows in FIG. 3(C). Alternatively, the path of motion can be circular, elliptical, or rectangular, for example.

Second Representative Embodiment

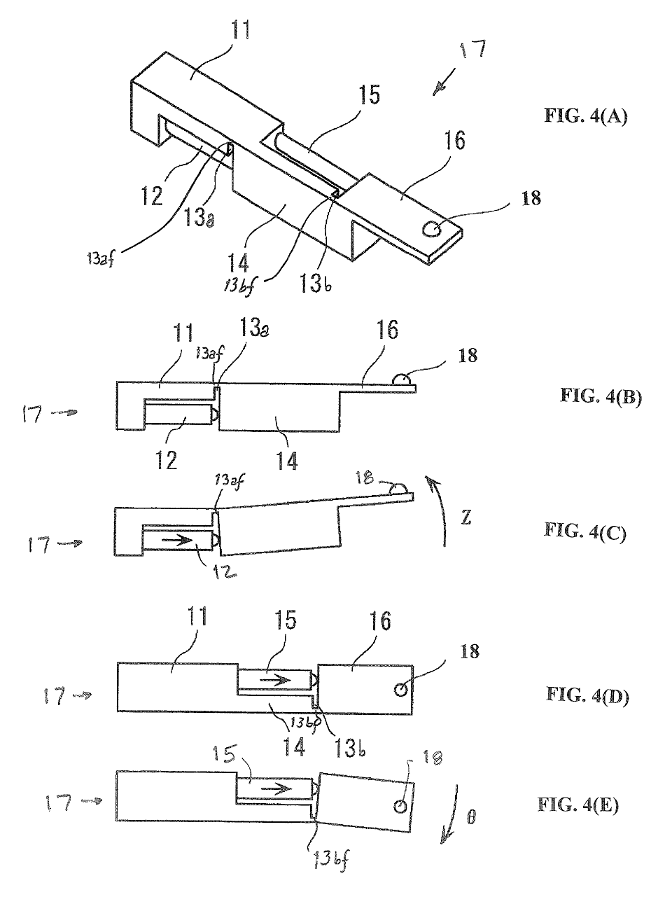

An actuator 17 according to this embodiment is shown in FIGS. 4(A)-4(E). As shown in FIG. 4(A), the actuator comprises a base 11, a Z-direction-drive piezoelectric element 12 (e.g., a piezo stack as known in the art), cutouts 13a, 13b defining respective flexures 13af, 13bf, a Z-direction lever 14, a θ-direction-drive piezoelectric element (e.g., piezo stack) 15, a θ-direction lever 16, and a contact point 18. Except for the piezoelectric elements 12, 15, the actuator 17 can be made from a non-magnetic, non-metallic material such as a plastic, ceramic, or the like that does not affect the charged particle beam.

As shown in the oblique view of FIG. 4(A), the actuator 17 is configured such that the two levers, namely, the Z-direction lever 14 and the θ-direction lever 16 (providing mutually perpendicular flexures 13af, 13bf defined by the respective cutouts 13a, 13b) are driven by the Z-direction-drive laminated piezoelectric element 12 and the θ-direction-drive piezoelectric element 15, respectively. The contact point 18 actually touches the under-surface of the wafer or reticle whenever the actuator 17 is appropriately energized.

FIGS. 4(B) and 4(C) are respective side views of the actuator 17. FIG. 4(B) shows the actuator 17 whenever the Z-direction-drive piezoelectric element 12 is not being energized. If a voltage is applied to the Z-direction-drive piezoelectric element 12, then the piezoelectric element 12 lengthens as shown in FIG. 4(C), causing the Z-direction lever 14 to pivot about the flexure 13af defined by the cutout 13a. This motion of the lever 14 amplifies the magnitude of motion of the Z-direction-drive piezoelectric element 12 and changes the longitudinal motion of the piezoelectric element 12 to a rotational movement of the lever 14 in the Z-axis direction (arrow in FIG. 4(C)).

FIGS. 4(D) and 4(E) are top views of the actuator 17. FIG. 4(D) shows the actuator 17 whenever the θ-direction-drive piezoelectric element 15 is not being energized. If a voltage is applied to the θ-direction-drive piezoelectric element 15, then the piezoelectric element 15 lengthens and, as shown in FIG. 4(E), causing the θ-direction lever 16 to pivot about the flexure 13bf defined by the cutout 13b. This motion of the lever 16 amplifies the magnitude of motion of the θ-direction-drive piezoelectric element 15 and changes the longitudinal motion of the piezoelectric element 12 to a rotational movement of the lever 16 in the θ-axis direction (arrow in FIG. 4(E)).

With the actuator 17 of this embodiment, rotation of the wafer or reticle in the θ-direction is possible only as a clockwise movement from a steady-state condition. However, the wafer or reticle can be rotated counterclockwise by imparting a pre-contact deformation of the actuators 17, as shown in FIG. 4(E), then imparting a deformation of the actuators 17 in the Z-direction sufficient to lift the wafer and achieve the steady-state condition shown in FIG. 4(D).

Third Representative Embodiment

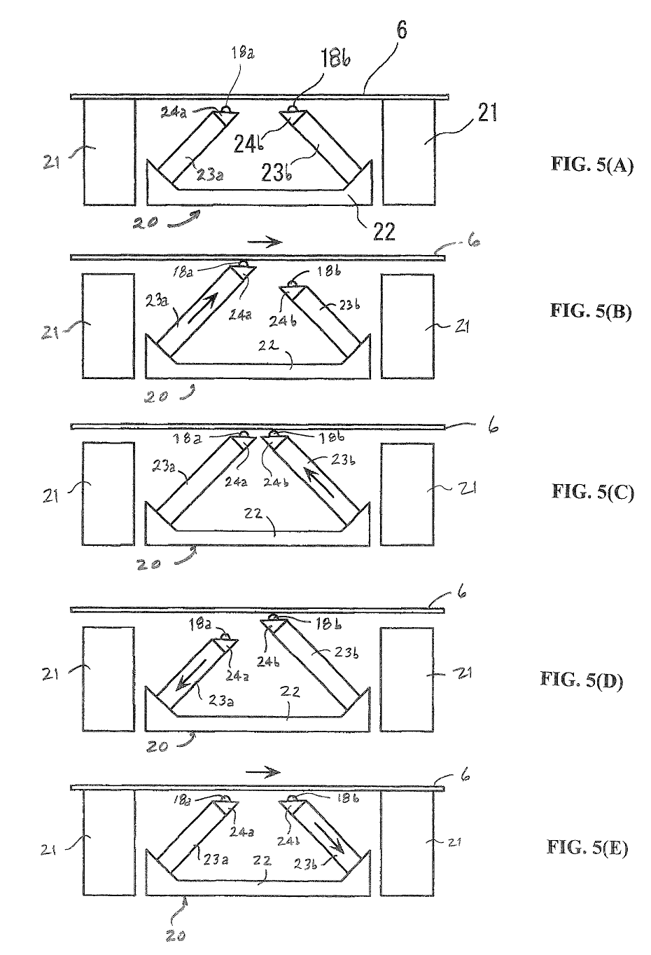

This embodiment, in the context of a wafer stage, is shown in FIGS. 5(A)-5(E). In an actuator 20 according to this embodiment, two piezoelectric elements 23a, 23b (e.g., respective “piezo stacks”) are situated so as to extend angularly upward toward each other (and toward the wafer 6) from their respective proximal ends. In FIG. 5(A), item 21 is a wafer table, item 22 is a support base, and items 24a, 24b are respective wedge-shaped members for the piezoelectric elements 23a, 23b.

As shown in FIG. 5(A), the two piezoelectric elements 23a, 23b are affixed proximally to and extend diagonally upward from the support base 22. As shown, the piezoelectric elements 23a, 23b extend toward each other at respective 45° angles relative to the wafer 6. Attached to the distal end of each piezoelectric element 23a, 23b is a respective 45° wedge-shaped member 24a, 24b and contact point 18a, 18b. Normally, three actuators 20 are situated and configured to contact the wafer 6 in a tripod manner at three places on the under-surface of the wafer 6, as shown generally in FIG. 1(B), for instance.

In the initial state shown in FIG. 5(A), both piezoelectric elements 23a, 23b are contracted, and the wafer 6 rests on the wafer table 21. Energization of the left-hand piezoelectric element 23 a causes it to lengthen sufficiently for the contact point 18a to touch and lift the wafer 6. Further extension of the piezoelectric element 23a moves the wafer 6 diagonally to the right (arrows in FIG. 5(B)). Subsequent energization of the right-hand piezoelectric element 23b causes it to lengthen sufficiently for the contact point 18b to contact and lift the wafer. Thus, the wafer 6 is now supported by both piezoelectric elements 23a, 23b (FIG. 5(C)). Then, as shown in FIG. 5(D), the left-hand piezoelectric element 23a is de-energized and retracted (arrow) so that the wafer 6 is supported only by the right-hand piezoelectric element 23b. Finally, the right-hand piezoelectric element 23b is de-energized and retracted diagonally (arrow) so that the wafer 6 is both lowered and moved to the right until the wafer is again supported by the wafer table 21, as shown in FIG. 5(E).

The wafer 6 (or reticle) can be rotated and/or moved laterally by repeating the sequence described above as many times as necessary. To such end, voltage of the same waveform but shifted in phase (desirably by 90°) can be applied to the left-hand and right-hand piezoelectric elements 23a and 23b. The direction of motion of the wafer 6 (or reticle) can be reversed by applying the “retracting” voltage to the other piezoelectric element (e.g., to the left-hand piezoelectric element 23a rather than to the right-hand piezoelectric element 23b).

Fourth Representative Embodiment

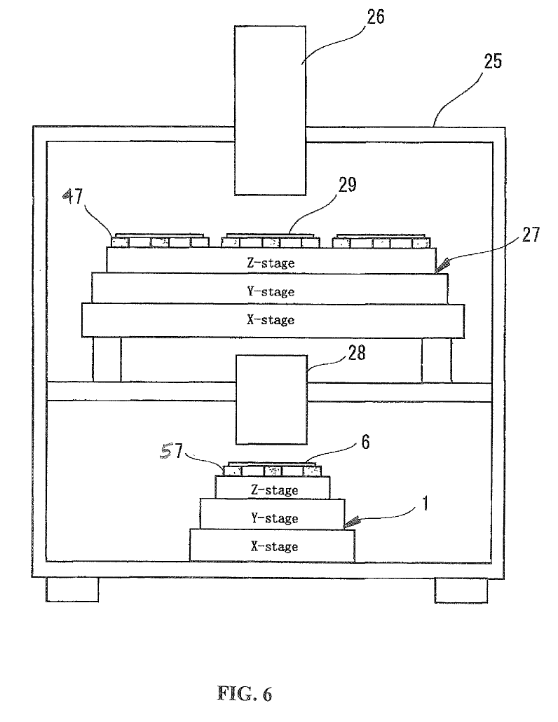

This embodiment, as shown generally in FIG. 6, is directed generally to an exemplary overall configuration of the reticle stage 27 and wafer stage 1 as used in a CPB microlithography apparatus. In the depicted embodiment, actuators (such as any of those described above) are used. In FIG. 6, item 25 is a vacuum chamber, item 26 is an irradiation-optical system, item 27 is a reticle stage, and item 28 is a projection-optical system. The irradiation-optical system 26 is situated above the vacuum chamber 25, and the reticle stage 27 is situated within the vacuum chamber 25. Similar to the wafer stage 1 described above in the first representative embodiment, the reticle stage 27 comprises an X-stage, a Y-stage, and a Z-stage. On the Z-stage is provided a reticle-movement mechanism comprising actuators 47, and on which are placed reticles 29.

In the figure, three reticles 29 have been placed on the reticle stage 27. Each reticle 29 is provided with a respective reticle-movement mechanism (including respective actuators 47) so that each reticle 29 can be adjusted independently. In this manner, all the reticles 29 can be adjusted before exposure, thereby eliminating the need to adjust reticle angular orientation during exposure.

The reticles 29 are irradiated with a charged particle beam emitted from the irradiation-optical system 26. The projection-optical system 28 is situated downstream of the reticle stage 27 and is used to transfer the respective patterns, defined by the reticles 29, by exposure onto the wafer 6. The wafer stage 1 is situated downstream of the projection-optical system 28. The wafer stage 1 comprises an X-stage, a Y-stage, and a Z-stage as described in the first representative embodiment. On the Z-stage is a wafer-movement mechanism that comprises actuators 57 such as any of the various actuators described above. The wafer 6 is placed on the reticle-movement mechanism.

It will be understood that, instead of or in addition to a reticle stage 27 configured to hold multiple reticles, as described above, the wafer stage 1 alternatively or additionally can be so configured. With such a configuration, individual alignment or orientation deviations in reticles or wafers can be determined and corrected independently before exposure, thereby eliminating the need to perform angular adjustments during exposure. This improves throughput. Also, use of a multiple-reticle reticle stage eliminates a need for a large θ-stage, thereby reducing the mechanical load on the underlying X-, Y-, and Z-stages.

Fifth Representative Embodiment

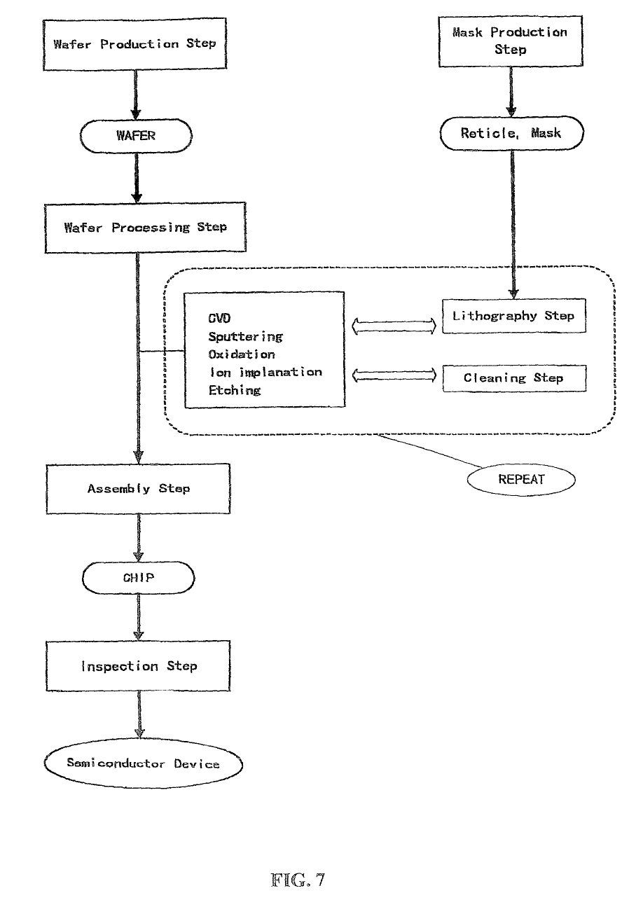

FIG. 7 is a flowchart of an exemplary microelectronic-fabrication method in which apparatus and methods according to the invention can be applied readily. The fabrication method generally comprises the main steps of wafer production (wafer manufacturing or preparation), reticle (mask) production or preparation; wafer processing, device (chip) assembly (including dicing of chips and rendering the chips operational), and device (chip) inspection. Each step usually comprises several sub-steps.

Among the main steps, wafer processing is key to achieving the smallest feature sizes (critical dimensions) and best inter-layer registration. In the waferprocessing step, multiple circuit patterns are layered successively atop one another on the wafer, forming multiple chips destined to be memory chips or main processing units (MPUs), for example. The formation of each layer typically involves multiple sub-steps. Usually, many operative microelectronic devices are produced on each wafer.

Typical wafer-processing steps include: (1) thin-film formation (by, e.g., sputtering or CVD) involving formation of a dielectric layer for electrical insulation or a metal layer for connecting wires or electrodes; (2) oxidation step to oxidize the substrate or the thin-film layer previously formed; (3) microlithography to form a resist pattern for selective processing of the thin film or the substrate itself; (4) etching or analogous step (e.g., dry-etching) to etch the thin film or substrate according to the resist pattern; (5) doping as required to implant ions or impurities into the thin film or substrate according to the resist pattern; (6) resist stripping to remove the remaining resist from the wafer; and (7) wafer inspection. Wafer processing is repeated as required (typically many times) to fabricate the desired microelectronic devices on the wafer.

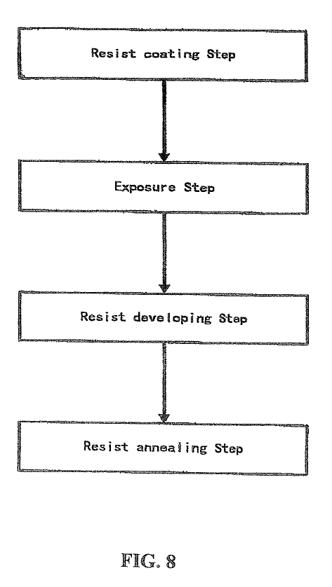

FIG. 8 provides a flowchart of typical steps performed in microlithography, which is a principal step in the wafer processing step shown in FIG. 7. The microlithography step typically includes: (1) resist-application step, wherein a suitable resist is coated on the wafer substrate (which an include a circuit element formed in a previous wafer-processing step); (2) exposure step, to expose the resist with the desired pattern by microlithography; (3) development step, to develop the exposed resist to produce the imprinted image; and (4) optional resist-annealing step, to enhance the durability of and stabilize the resist pattern.

The process steps summarized above are all well known and are not described further herein.

Whereas the invention has been described in connection with a representative embodiment, it will be understood that the invention is not limited to that embodiment. On the contrary, the invention is intended to encompass all modifications, alternatives, and equivalents as may be included within the spirit and scope of the invention, as defined by the appended claims.

What is claimed is:

1. In a charged-particle-beam (CPB) microlithography apparatus used for transferring a pattern, defined by a reticle, to a substrate, a stage for holding the reticle or substrate, the stage comprising:
an X-direction-movement stage portion configured to move the reticle or substrate along an X-axis direction;
a Y-direction-movement stage portion configured to move the reticle or substrate along a Y-axis direction;
a Z-direction-movement stage portion configured to move the reticle or substrate along a Z-axis direction; and
at least one actuator situated and configured to move the reticle or substrate relative to the stage, the actuator being made of a non-magnetic material and being configured to exhibit at least two degrees of freedom of movement relative to the stage sufficient to cause said movement of the reticle or substrate.

2. The stage of claim 1, configured as a wafer stage for holding the substrate.

3. The stage of claim 1, configured as a reticle stage for holding the reticle.

4. The stage of claim 1, wherein the actuator has a proximal end mounted to the stage and a distal free end configured to be moved relative to the proximal end.

5. The stage of claim 4, wherein:
the actuator is a cylindrical piezoelectric element; and
the proximal end is a first end of the piezoelectric element and the distal end is a second end of the piezoelectric element.

6. The stage of claim 4, wherein the actuator comprises:
a first lever connected to the proximal end via a first flexure;
a second lever connected to the first lever via a second flexure, wherein the first and second flexures are oriented at right angles relative to each other;
a first piezoelectric element situated and configured to cause pivoting motion of the first lever about the first flexure relative to the proximal end whenever the first piezoelectric element is appropriately energized; and
a second piezoelectric element situated and configured to cause pivoting motion of the second lever about the second flexure relative to the first lever whenever the second piezoelectric element is appropriately energized.

7. The stage of claim 1, wherein the actuator comprises two piezo stacks each having a proximal end mounted to the stage and a distal free end configured to be moved relative to the proximal end, the piezo stacks being situated relative to each other such that the respective distal free ends extend angularly from the stage toward the reticle or substrate, as well as angularly toward each other.

8. The stage of claim 1, comprising at least three actuators situated peripherally relative to the reticle or substrate so as to support, whenever the actuators are appropriately energized, the reticle or substrate in a tripod manner relative to the stage.

9. The stage of claim 8, wherein the actuators are located substantially equiangularly relative to each other.

10. The stage of claim 9, wherein each actuator has a proximal end mounted to the stage and a distal free end configured to be moved relative to the proximal end.

11. The stage of claim 1, wherein the actuator is configured to move the reticle or substrate, while the reticle or substrate is resting on a support, by lifting the reticle or substrate relative to the support, moving the reticle or substrate relative to the support, and then replacing the reticle or substrate on the support.

12. The stage of claim 1, wherein the actuator is configured to manipulate the reticle or substrate relative to the stage so as to control a positional deviation of the reticle or substrate from a reference position, so as to maintain a position of the reticle or substrate to within a range that can be compensated for by a charged-particle-beam optical system.

13. The stage of claim 1, configured to hold multiple reticles or substrates, the stage comprising multiple actuators each situated and configured to move a respective reticle or substrate relative to the stage, each actuator being made of a non-magnetic material and being configured to exhibit at least two degrees of freedom of movement relative to the stage sufficient to cause said movement of the reticle or substrate.

14. In a charged-particle-beam microlithography apparatus used for transferring a pattern from a reticle to a substrate, a stage for holding the reticle or substrate, comprising:
a table portion for holding the reticle or substrate;
at least one stage portion situated and configured to move the table portion in a respective direction selected from the group consisting of an X-axis direction, a Y-axis direction, a Z-axis direction, an “r” direction, and a θ-direction; and
at least one actuator situated and configured to lift the reticle or substrate from the table portion, move the reticle or substrate relative to the table portion, and lower the reticle or substrate to the table portion, the actuator being non-magnetic and configured to exhibit at least two degrees of freedom of motion relative to the table portion.

15. A charged-particle-beam (CPB) microlithography apparatus, comprising:
an irradiation-optical system;
a projection-optical system; and
a stage for holding a reticle or substrate relative to the irradiation-optical system and projection-optical system, the stage comprising an X-directionmovement stage portion configured to move the reticle or substrate along an X-axis direction, a Y-direction-movement stage portion configured to move the reticle or substrate along a Y-axis direction, a Z-direction-movement stage portion configured to move the reticle or substrate along a Z-axis direction, and at least one actuator situated and configured to move the reticle or substrate relative to the stage, the actuator being made of a non-magnetic material and being configured to exhibit at least two degrees of freedom of movement relative to the stage sufficient to cause said movement of the reticle or substrate.

16. The CPB microlithography apparatus of claim 15, wherein the stage is configured as a wafer stage for holding the substrate.

17. The CPB microlithography apparatus of claim 15, wherein the stage is configured as a reticle stage for holding the reticle.

18. The CPB microlithography apparatus of claim 15, wherein:
the actuator is a cylindrical piezoelectric element having a proximal end mounted to the stage and a distal free end configured to be moved relative to the proximal end; and
the proximal end is a first end of the piezoelectric element and the distal end is a second end of the piezoelectric element.

19. The CPB microlithography apparatus of claim 15, wherein the actuator comprises (i) a first lever connected to the proximal end via a first flexure; (ii) a second lever connected to the first lever via a second flexure, wherein the first and second flexures are oriented at right angles relative to each other; (iii) a first piezoelectric element situated and configured to cause pivoting motion of the first lever about the first flexure relative to the proximal end whenever the first piezoelectric element is appropriately energized; and (iv) a second piezoelectric element situated and configured to cause pivoting motion of the second lever about the second flexure relative to the first lever whenever the second piezoelectric element is appropriately energized.

20. The CPB microlithography apparatus of claim 15, wherein the actuator comprises two piezo stacks each having a proximal end mounted to the stage and a distal free end configured to be moved relative to the proximal end, the piezo stacks being situated relative to each other such that the respective distal free ends extend angularly from the stage toward the reticle or substrate, as well as angularly toward each other.

21. The CPB microlithography apparatus of claim 15, comprising at least three actuators situated peripherally relative to the reticle or substrate so as to support, whenever the actuators are appropriately energized, the reticle or substrate in a tripod manner relative to the stage.

22. The CPB microlithography apparatus of claim 15, wherein the actuator is configured to move the reticle or substrate, while the reticle or substrate is resting on a support, by lifting the reticle or substrate relative to the support, moving the reticle or substrate relative to the support, and then replacing the reticle or substrate on the support.

23. The CPB microlithography apparatus of claim 15, wherein the actuator is configured to manipulate the reticle or substrate relative to the stage so as to control a positional deviation of the reticle or substrate from a reference position, so as to maintain a position of the reticle or substrate to within a range that can be compensated for by a charged-particle-beam optical system.

24. The CPB microlithography apparatus of claim 15, wherein the stage is configured to hold multiple reticles or substrates, the stage comprising multiple actuators each situated and configured to move a respective reticle or substrate relative to the stage, each actuator being made of a non-magnetic material and being configured to exhibit at least two degrees of freedom of movement relative to the stage sufficient to cause said movement of the reticle or substrate.

25. In a charged-particle-beam (CPB) microlithography method in which a pattern, defined by a reticle, is transferred to a substrate using a charged-particle energy beam passing through a CPB optical system having an optical axis, a method for moving the reticle or substrate relative to the optical axis, comprising:
placing the reticle or substrate on a stage;
providing an actuator relative to the stage, the actuator being made of a nonmagnetic material and being configured to exhibit at least two degrees of freedom of movement relative to the stage; and
energizing the actuator so as to cause movement of the actuator relative to the stage, such that the actuator causes movement of the reticle or substrate relative to the stage.

26. The method of claim 25, wherein:
the actuator is provided as a cylindrical piezoelectric element having a proximal end mounted to the stage and a distal free end configured to be moved relative to the proximal end;
the proximal end is a first end of the piezoelectric element and the distal end is a second end of the piezoelectric element; and
energizing the actuator causes the distal end to contact the reticle or substrate in a manner resulting in movement of the reticle or substrate relative to the stage.

27. The method of claim 25, wherein the actuator is provided with (i) a first lever connected to the proximal end via a first flexure; (ii) a second lever connected to the first lever via a second flexure, wherein the first and second flexures are oriented at right angles relative to each other; (iii) a first piezoelectric element situated and configured to cause pivoting motion of the first lever about the first flexure relative to the proximal end whenever the first piezoelectric element is appropriately energized; and (iv) a second piezoelectric element situated and configured to cause pivoting motion of the second lever about the second flexure relative to the first lever whenever the second piezoelectric element is appropriately energized.

28. The method of claim 25, wherein the actuator is provided with two piezo stacks each having a proximal end mounted to the stage and a distal free end configured to be moved relative to the proximal end, the piezo stacks being situated relative to each other such that the respective distal free ends extend angularly from the stage toward the reticle or substrate, as well as angularly toward each other.

29. The method of claim 25, wherein at least three actuators are provided, the actuators being situated peripherally relative to the reticle or substrate so as to support, whenever the actuators are appropriately energized, the reticle or substrate in a tripod manner relative to the stage.

30. The method of claim 25, wherein energizing the actuator causes movement of the reticle or substrate, while the reticle or substrate is resting on a support, by lifting the reticle or substrate relative to the support, moving the reticle or substrate relative to the support, and then replacing the reticle or substrate on the support.

31. The method of claim 31, wherein energizing the actuator causes manipulation of the reticle or substrate relative to the stage in a manner by which a positional deviation of the reticle or substrate from a reference position is controlled, thereby maintaining a position of the reticle or substrate to within a range that can be compensated for by a charged-particle-beam optical system.

32. A microelectronic-fabrication process, comprising:
(a) preparing a wafer;
(b) processing the wafer; and
(c) assembling devices formed on the wafer during steps (a) and (b), wherein step (b) comprises a method for performing CPB microlithography as recited in claim 25.

33. A microelectronic-device fabrication process, comprising the steps of:
(a) preparing a wafer;
(b) processing the wafer; and
(c) assembling devices formed on the wafer during steps (a) and (b), wherein step (b) comprises the steps of (i) applying a resist to the wafer; (ii) exposing the resist; and (iii) developing the resist; and step (ii) comprises providing a CPB microlithography apparatus as recited in claim 15; and using the CPB microlithography apparatus to expose the resist with the pattern defined on the reticle.

34. A microelectronic device produced by the method of claim 33.
